(19) United States
(12) Patent Application Publication
(10) Pub. No.: US 2010/0106386 A1
(43) Pub. Date: Apr. 29, 2010

(54) METHOD FOR BRAKING A HYBRID VEHICLE AND METHOD FOR IMPROVING A HYBRID VEHICLE IMPLEMENTING SAID METHOD

(75) Inventors: Joseph Krasznai, Mezy-sur-Seine (FR); Armand Boatas, Sevres (FR); Vincent Mulot, Paris (FR); Remy Delplace, Bermont (FR); Olivier Mechin, Hericourt (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES S.A., Velizy Villacoublay (FR)

(21) Appl. No.: 12/519,755

(22) PCT Filed: Dec. 18, 2007
(86) PCT No.: PCT/FR07/52549

§ 371 Date: Dec. 4, 2009

(30) Foreign Application Priority Data
Dec. 18, 2006 (FR) 0655609

(51) Int. Cl. B60W 10/18; G06F 19/00; B60W 20/00

(52) U.S. Cl. 701/70; 477/4; 903/947

(57) ABSTRACT

The invention relates to a method for braking a hybrid vehicle (1) including a thermal engine and an electric machine (3) defining a traction chain. According to this method, when the depression of the brake pedal is detected, an additional electric braking torque is added (Cf_recup), and the additional electric braking torque is modulated according to the position of the brake pedal as measured by a pedal stroke sensor (42) and/or to the braking hydraulic pressure as measured by a braking pressure sensor (43).

The invention relates to a braking method for hybrid vehicles in which a regenerative braking torque and a dissipative braking torque are applied to the wheels. A particular purpose of the invention is to increase the regenerative braking torque applied to the wheels by the electric machine while ensuring good control of this vehicle.

Braking systems are known in which a regenerative braking torque and a dissipative braking torque are applied to the wheels. The regenerative braking torque is applied to the wheels by the action of an electric machine acting as a generator to recharge a battery to which it is connected. The dissipative braking torque is applied to the wheels by means of disk or drum brakes applying a friction force to a mobile element rotating with the wheels.

Two types of regenerative braking exist, and are distinguished by European legislation on braking. The first type is a category A regenerative system that exerts a braking torque on the wheels without any driver action on the brake pedal. A representation of the braking characteristics of such a system is shown in FIG. 1.

One can observe that the regenerative torque Tem1 applied to the wheels by the electric machine as a function of the amount of brake pedal depression (lower left quadrant) is constant regardless of the amount of brake pedal depression. The sum of the torque applied to the wheels by the brakes Thydr1 and the electric machine Tem1 increases as a function of the amount of brake pedal depression. Implementing the category A system does not require any a priori adaptation of the hybrid vehicle power train.

The second type is a category B regenerative system that exerts a braking torque controlled by the brake pedal. The invention has a useful application in this type of system. In particular, these systems make it possible to uncouple the brake pedal action from the torque produced by the conventional dissipative braking system. This way, they have the possibility of controlling the distribution between regenerative braking by the electric drivetrain and dissipative braking by the conventional hydraulic braking system.

The disadvantages of these devices are that they introduce a significant additional cost for the vehicle, as well as usage quality and operational safety risks due to their inherent complexity.

Document JP2003-284202 describes a method for managing distribution between the conventional braking system and regenerative braking by the electric machine. This method has a step that consists in increasing regenerative braking when the brake pedal is actuated. However, this method involves an inherent modification of the hydraulic braking system.

The regenerative braking device according to the invention aims to address the aforementioned disadvantages.

It is supported in this purpose by minor modifications to the pre-existing and proven braking system hardware architecture. Thus, adding a pressure and/or pedal stroke sensor to a category A system makes it possible to optimize energy recovery during braking phases. Sensors are added in a “non-intrusive” manner, i.e., without inherently modifying the elements of the system.

In addition to deceleration upon pedal release, the invention carries out the following steps, consisting in:
adding supplemental electric braking torque (insofar as the state of the electric machine allows) when brake pedal pressure is detected. Brake pedal pressure can be detected by a BLS-type inductive sensor and/or by the pedal stroke sensor and/or by the hydraulic brake pressure sensor, and
modulating and controlling this supplemental electric braking torque according to the brake pedal position as measured by the pedal stroke sensor and/or the hydraulic braking pressure as measured by the brake pressure sensor.

In an implementation, the brake system supervisor, which is an ABS or ESP calculator, detects the braking scenario and controls the application of the supplemental electric braking torque according to this scenario. The scenario depends in particular on the vehicle speed, the road trajectory (curved or straight), and tire adhesion to the road (dry or wet road adhesion).

The brake supervisor additionally controls modulation of the regenerative braking torque according to the position of the brake pedal as measured by the pedal stroke sensor and/or the hydraulic braking pressure as measured by the pressure sensor. The brake supervisor also controls modulation of the regenerative braking torque according to the vehicle speed and the gearbox ratio engaged. The brake supervisor additionally modulates the regenerative braking torque so that it never exceeds an “acceptable” limit in terms of comfort for the driver.

However, when activating braking control functions such as ABS (Anti-Lock Braking System in English) or ESP (Electronic Stability Program in English), which are used when the vehicle is losing adhesion or is not following the desired trajectory, the feedbacks and control laws specific to these functions (loaded in the control unit) take over to control the supplemental electric braking torque.

The setpoint for supplemental regenerative braking torque thus determined by the brake supervisor is then transmitted to the calculator that controls the electric machine. The latter controls the electric machine so as to make it produce this regenerative torque.

The invention thus relates to a braking method for a hybrid vehicle comprising a heat engine and an electric machine forming a power train, this power train being connected to wheels of the vehicle, this vehicle comprising a brake pedal that controls vehicle braking, this method comprising the following steps:
when pressure is detected on the vehicle's brake pedal,
a dissipative braking torque is applied to the wheels by means of brakes connected to a hydraulic braking circuit, with these brakes rubbing on elements that rotate with the wheels, and
a supplemental braking torque is applied to the wheels by means of the electric machine,
this supplemental braking torque being modulated as a function of the brake pedal stroke and/or the hydraulic braking pressure, with this torque being dependent on the gear ratio engaged as well.

In an implementation, in order to modulate the braking torque to modulate this supplemental braking torque, it additionally comprises the following steps:
measuring the maximum braking torque of the electric machine,
weighting this maximum braking torque with a corrective gain that depends on the gear ratio engaged, this corrective gain being dependent as well on the vehicle speed for a given gear ratio and at least one parameter from among braking pressure and brake pedal stroke, and
controlling the electric machine so that the electric braking torque applied to the wheels as a complement to dissipative braking is substantially equal to the weighted maximum braking torque.

The invention also relates to a method for improving a hybrid vehicle comprising a heat engine and an electric machine that form a power train, this power train being connected to wheels of the vehicle, wherein:
a pedal stroke sensor and/or a pressure sensor is added so that
the supplemental braking torque applied to the wheels by the electric machine when the brake pedal is depressed is modulated as a function of the brake pedal stroke and/or the hydraulic braking pressure.

The following description and accompanying figures will make the invention more easily understood. These figures are given only as an illustration, and are in no way an exhaustive representation of the invention. They show:

FIG. 1 (already described): a curve representing the torque applied to the wheels as a function of the amount of brake pedal depression for a regenerative braking method according to the state of the art;

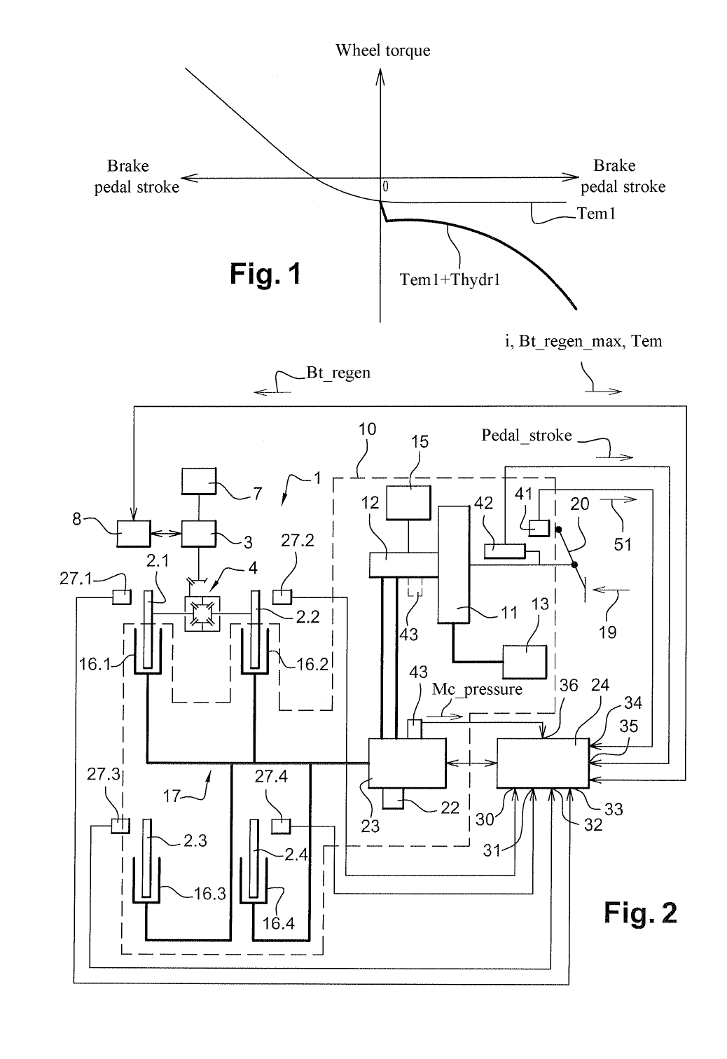

FIG. 2: a schematic representation of a hybrid vehicle that uses the regenerative braking method according to the invention;

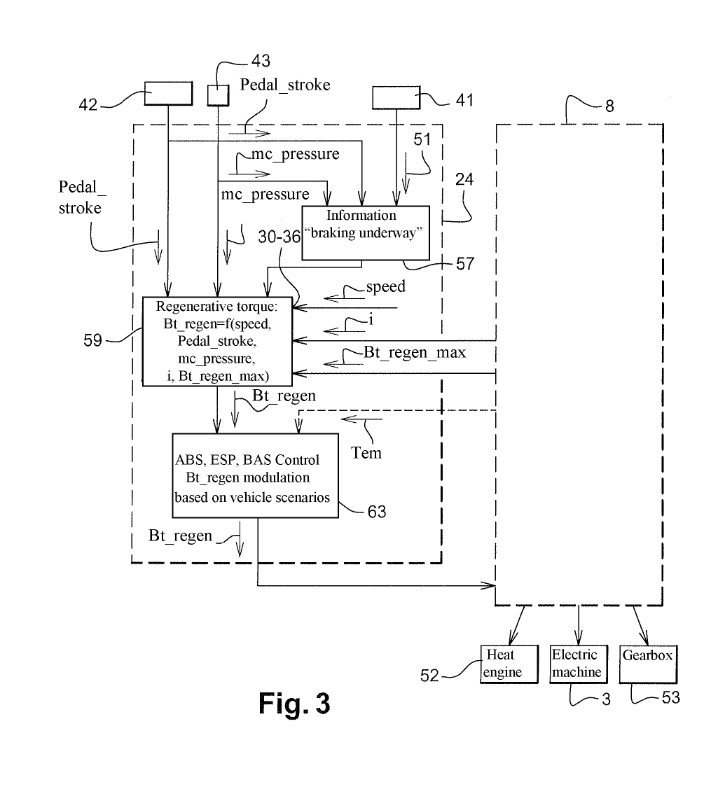

FIGS. 3-5: schematic representations of command management according to the invention for the regenerative torque applied by the electric machine in a braking system according to the invention comprising a depression sensor and/or a hydraulic pressure sensor;

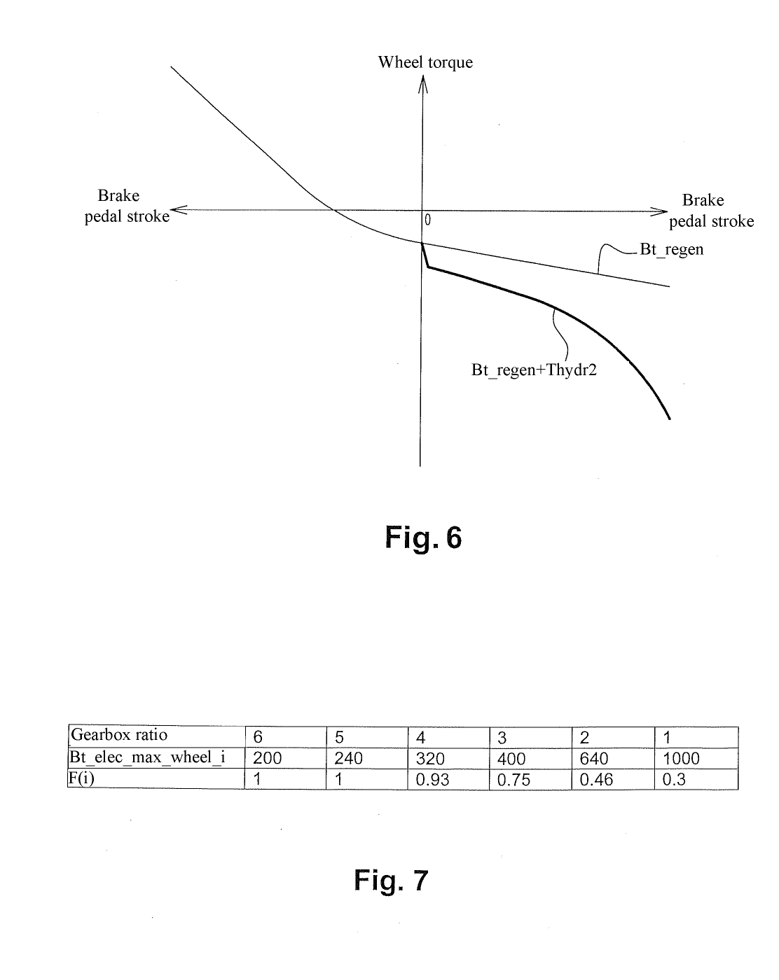

FIG. 6: a curve representing the torque applied to the wheels as a function of the amount of brake pedal depression for a regenerative braking method according to the invention;

FIG. 7: a table indicating the value of a corrective gain F(i) dependent on the gear ratio engaged, which is used to calculate the regenerative braking torque.

Identical elements retain the same reference from one figure to another.

FIG. 2 shows a braking control system according to the invention, applied to a hybrid vehicle 1. The vehicle wheels are represented by their respective associated brake discs. Front wheels 2.1, 2.2 of this vehicle that serve as drive wheels are driven by an electric machine 3 and a heat engine (not shown). This machine 3 and this engine can be connected to one another, for example, via a clutch, and they can be accompanied by a computer-controlled gearbox or a CVT (Continuously Variable Transmission).

The electric machine 3 is connected to the shaft of these wheels via a differential assembly 4. This machine 3 is also connected to a battery 7 via a power circuit.

The electric machine 3 transmits a regenerative braking torque to the wheels 2.1-2.4 when it is operating in generator mode to recharge the battery 7 and its shaft is being driven by the wheels. This recharge phase occurs during deceleration or braking.

A supervisor 8 controls the torque applied by the power train comprised of the heat engine and the electric machine 3. In particular, the supervisor 8 controls the braking torque applied to the wheels 2.1-2.4 by the machine 3.

In addition, the vehicle 1 has a hydraulic brake system 10. This system 10 has a booster device for pressure-actuated braking 11 that amplifies the force applied by the driver on the pedal 20. To this end, the device 11 is connected to a vacuum source 13 that makes it possible to have different pressures on the piston that it comprises (not shown). This device 11 is connected to a master cylinder 12 supplied with fluid by a tank 15. This master cylinder 12 is connected to the brakes 16.1-16.4 via a system 17 of pipelines.

Thus, when the driver presses 19 on the pedal 20 in order to brake, the amplifier assembly 11 and master cylinder 12 transform the mechanical force provided by the driver when pressing on the pedal into hydraulic pressure. The pipelines then transmit this hydraulic pressure to the brakes 16.1-16.4. These brakes transform this pressure into a force capable of actuating the pads against the four discs 2.1-2.4.

The vehicle additionally comprises an ABS-type system. This system comprises a hydraulic group 23 connected to the master cylinder 12 and the pipeline system 17. This hydraulic group 23 is equipped with a pump 22 and is associated with a brake supervisor 24. This hydraulic group 23 controls the hydraulic pressure applied by the brakes. The ABS system further comprises sensors 27.1-27.4 that measure the speed of the wheels, which are connected to inputs 30-33 of the supervisor 24.

This way, as soon as a wheel 2.1-2.4 of the vehicle registers an abnormal rotational speed (slip), the supervisor 24 prompts the hydraulic group 23 to ease off partially or completely on the wheel by lowering or overpressuring the hydraulic pressure, depending on the type of brake being used, in the relevant brake.

In FIG. 2, the dissipative braking torque is applied to all four wheels, whereas the electric braking torque is applied only to the tractive or drive axle. Nonetheless, the invention is also applicable with an all-wheel-drive transmission.

In addition, the vehicle 1 comprises a BLS-type (Brake Light Switch in English) brake switch sensor 41 that detects brake pedal depression. This sensor is connected to an input of the calculator 24.

The vehicle 1 also comprises sensors that make it possible to estimate the braking intensity requested by the driver. That is, the vehicle comprises a pedal stroke or master cylinder displacement sensor 42 and/or a brake pressure sensor 43 that measures the pressure generated by the master cylinder. These sensors 42, 43 are in addition to a standard ABS configuration. In an embodiment, the brake pressure sensor 43 is installed either at the site of the master cylinder 12 or at the site of the hydraulic unit 23.

As a variant, the unit 24 also comprises an ESP function that can correct the vehicle's trajectory by calculating an expected trajectory. In this case, the pressure sensor 43 is already present on the hydraulic unit 23, and it is not helpful to add another.

Based on the input signals it receives, and particularly the signals sent by the sensors 42 and 43, the calculator 24 sends instructions to the power train calculator 8, which modulates the regenerative torque of the electric machine 3.

More precisely, FIGS. 3 to 5 describe how the control laws of the invention are laid out in the (ABS or ESP) brake calculator 24 and the supervisor 8, which controls the various elements of the hybrid power train, in particular the heat engine 52, the electric machine 3, and the gearbox 53.

FIG. 3 shows the case in which the brake pedal stroke sensor 42 and the pressure sensor 43 are being used. In this case, the signals 51, “pedal_stroke” and “mc_pressure”, emitted by the sensors 41-43, respectively, are input into a module 57 that detects whether or not any braking is under way.

The information 58 produced as output from the module 57 is transmitted to the module 59 with the values for brake pedal depression (or stroke) “pedal_stroke” and braking pressure “mc_pressure” as measured by the sensors 42 and 43, respectively. Likewise, the vehicle speed value “speed” (calculated from signals sent by the speed sensors 27.1-27.4), the value of the gear ratio engaged “i”, and the value of the maximum electric braking torque “Bt_regen-max” that can be produced by the electric machine are transmitted to the module 59. It should be noted that the values “i”, and “Bt_regen-max” are transmitted to the brake supervisor 24 by the power train supervisor 8.

The module 59 then calculates the regenerative electric braking torque setpoint Bt_regen based on these values received. More precisely, in the case in FIG. 3, the module 59 calculates Bt_regen from the following relation:

Bt_regen=Bt_regen_max×Fps_{—}i(pedal_stroke,speed)×Fmcp_i(mc_pressure,speed),

“Fps_i” is a function that yields a corrective gain value between 0 and 1 as a function of the brake pedal stroke “pedal_stroke” and the vehicle speed “speed”. Typically, this function is a tabulation with two inputs (“pedal_stroke” and “speed”) and one output (gain between 0 and 1). How the tabulation is parameterized depends on the gearbox ratio “i” engaged. Thus, there is a parameter set and a specific tabulation for each gearbox ratio (i=neutral, 1, 2, 3, etc.).

“Fmcp_i” is a function that yields a corrective gain value between 0 and 1 as a function of the braking pressure and the vehicle speed. Typically, this function is a tabulation with two inputs (“mc_pressure” and “speed”) and one output (gain between 0 and 1). How the tabulation is parameterized depends on the gearbox ratio engaged. Thus, there is a parameter set and a specific tabulation for each gearbox ratio (i=neutral, 1, 2, 3, etc.).

In particular scenarios such as braking on a curve, emergency braking (BAS braking mode) or loss of adhesion, the ABS or ESP control functions are activated. In this case, a module 63 that comprises the feedback and control laws specific to the ABS and/or ESP functions takes over to calculate the regenerative braking torque “Bt_regen” and adjusts the value of this setpoint to these particular scenarios.

The electric braking setpoint “Bt_regen” is then sent by the brake supervisor 24 to the power train supervisor 8, which controls the machine 3 in order to generate the requested electric braking torque.

During normal operation, the torque setpoint “Bt_regen” is transmitted by the brake supervisor 24 to the power train supervisor 8 without being adjusted by the module 63.

As a variant, if the value “Tem” of the actual torque applied to the wheels by the electric machine is available, the module 63 uses this value to adjust its control of the machine. More precisely, the module 63 compares the torque setting “Bt_regen” to the value “Tem” so that the module 63 can fine-tune the value of the setpoint “Bt_regen” sent to the supervisor 8. The value “Tem”, which is measured or estimated, is provided to the brake supervisor 24 by the supervisor 8.

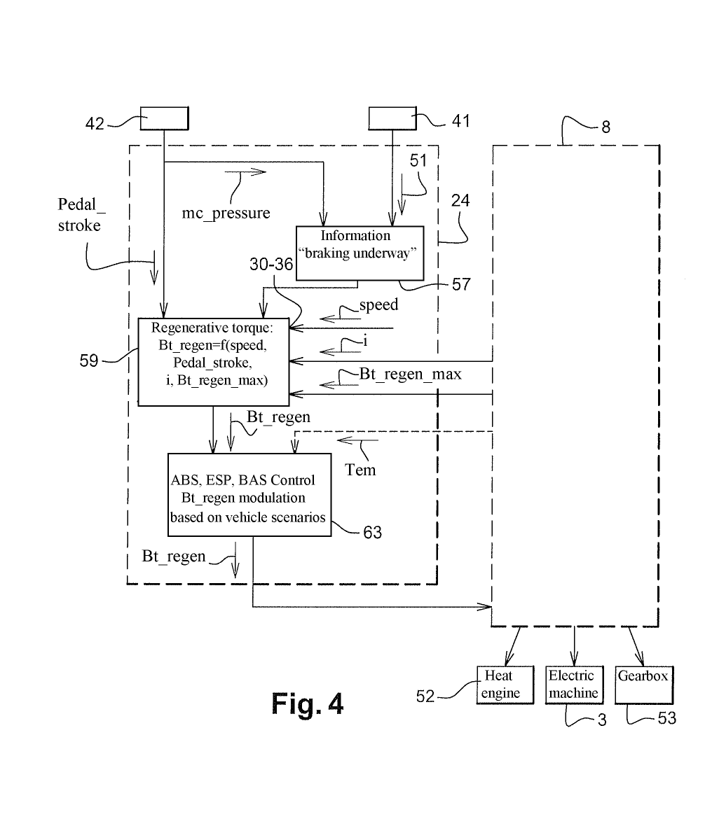

FIG. 4 shows a variant of an implementation of the method according to the invention in which only a brake pedal stroke sensor 42 is used. In this case, the value “mc_pressure” is not available and: Bt_regen=Bt_regen_max×Fps_i(pedal_stroke, speed).

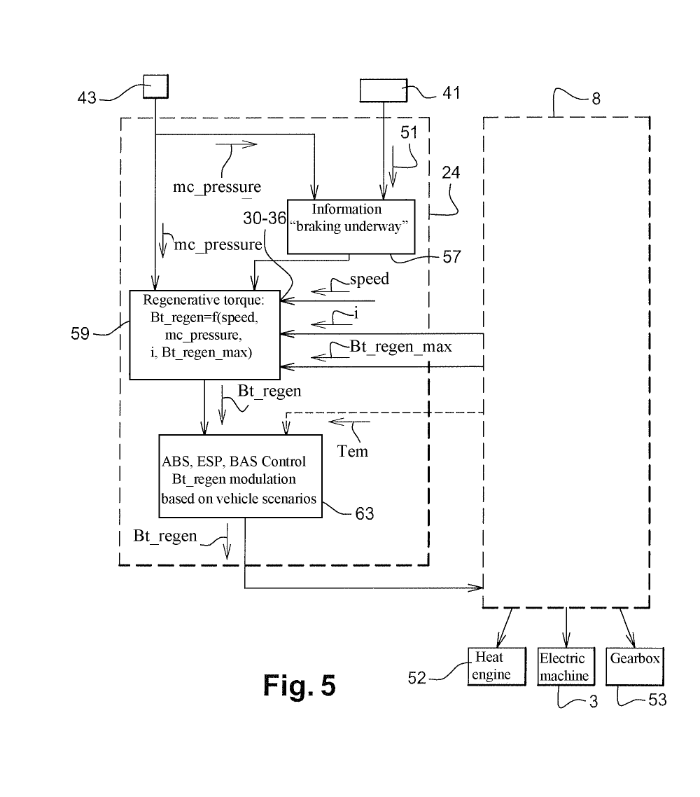

FIG. 5 shows a variant of an implementation of the method according to the invention in which only a brake pressure sensor 43 is used. In this case, the value “pedal_stroke” is not available, and: Bt_regen=Bt_regen_max×Fmcp_i(mc_pressure, speed).

The vehicle 1 has failure detection capabilities for the BLS sensor 41, the brake pedal stroke sensor 42, the master cylinder pressure sensor 43, and the information flow between the power train calculator 8 and the brake supervisor 24. When one of these elements fails, the function that adjusts the regenerative torque from the electric machine as a function of brake pedal depression (“pedal_stroke”) and/or hydraulic braking pressure (“mc_pressure”) is disabled.

FIG. 6 shows a curve that represents the regenerative torque Bt_regen applied to the wheels by the electric machine as a function of the amount of brake pedal depression (lower left quadrant). This torque Bt_regen increases substantially linearly with the amount of brake pedal depression. The curve thus makes it obvious that the regenerative braking method according to the invention makes it possible to have more braking torque applied to the wheels by the machine (Bt_regen) than with a state-of-the-art method (see Tem1 in FIG. 1).

The second curve represents the sum of the torques applied to the wheels by the brakes Thydr2 and the electric machine Bt_regen. This curve is identical to the one in FIG. 1. During braking, the torque applied by the brakes is therefore less in the method according to the invention than in the state-of-the-art method. While optimizing energy recovery during braking phases, the method according to the invention thereby makes it possible to reduce wear and tear on the brakes as well.

As a variant, the module 59 calculates the setpoint for regenerative electric braking torque “Bt_regen” according to the following relation:

Bt_regen=Bt_regen_max×Fps(pedal_stroke)×Fmcp(mc_pressure)×F(i)

Where F(i)=Bt_elec_max_acceptable/Bt_elec_max_wheel_{—}i

“Bt_elec_max_wheel_i” is the value of the maximum electric braking torque that the electric machine is capable of providing to the wheels for each gear ratio i. This value corresponds to torque saturation due to the electric machine's structure. It corresponds to the value of the maximum electric braking torque to the wheels that can be produced by the electric machine in nominal operating conditions.

“Bt_regen_max”, given by the engine calculator, is the value of the maximum electric torque that can be generated by the machine at instant t, the moment braking occurs. “Bt_regen_max” thus depends in particular on the state of the power train, the temperature of the electric machine, and the state of charge of the batteries. When the electric machine is operating in nominal conditions, “Bt_regen_max” is equal to “Bt_elec_max_wheel_i”, and otherwise, “Bt_regen_max” is different from (less than) “Bt_elec_max_wheel_i”.

“Bt_elec_max_acceptable” is the maximum acceptable level of electric torque with regard to braking comfort for the driver. It may be advantageous to have this level of electric braking torque be substantially constant regardless of the gear ratio engaged. In an example, “Bt_elec_max_acceptable” is 300 Nm.

Furthermore, the corrective gain “Fps” is between 0 and 1. In an example, the gain “Fps” varies linearly between 0 and 1 as a function of brake pedal depression “pedal_stroke” for the first 20 mm of this depression, with Fps being 0 for zero depression and 1 for 20 millimeters depression.

The corrective gain “Fmcp” is between 0 and 1. In an example, the gain “Fmcp” varies linearly between 0 and 1 as a function of the pressure generated “mc_pressure” by the master cylinder between 0 and 10 bars, with “Fmcp” being 0 for 0 bars pressure and 1 for 10 bars pressure.

FIG. 7 shows a table indicating the corrective gain values F(i) between 0 and 1 as a function of the gearbox ratio engaged i, for a maximum acceptable torque “Bt_elec_max_acceptable” of 300 Nm. The values for maximum electric braking torque that the electric machine is capable of providing to the wheels “Bt_elec_max_wheel_i”, which vary as a function of the gear ratio i engaged, are indicated for a given standard gearbox. If the ratio Bt_elec_max_acceptable/Bt_elec_max_wheel_i is greater than 1, F(i) takes the value 1.

As a variant, “Fps” and “Fmcp” additionally depend on the vehicle speed. As a variant, the corrective gains “Fps” or “Fmcp” can be selected so that no matter what gear ratio is engaged, the level of electric braking torque applied to the wheels “Bt_regen” is substantially equal to “Bt_elec_max_acceptable”.

1. Braking method for a hybrid vehicle comprising a heat engine and an electric machine forming a power train, this power train being connected to wheels of the vehicle, this vehicle comprising a brake pedal that controls vehicle braking, this method comprising the following steps:
when pressure is detected on the brake pedal of the vehicle,
a dissipative braking torque is applied to the wheels by means of brakes connected to a hydraulic braking circuit, with these brakes rubbing on elements that rotate with the wheels, and
a supplemental braking torque (Bt_regen) is applied to the wheels by means of the electric machine,
this supplemental braking torque (Bt_regen) being modulated as a function of the brake pedal stroke (“pedal_stroke”) and/or the hydraulic braking pressure (“mc_pressure”), with this braking torque being additionally dependent on the gear ratio engaged (i).

2. Method according to claim 1, wherein, in order to modulate this supplemental braking torque, the method additionally comprises the following steps:
measuring the maximum braking torque (Bt_regen_max) of the electric machine,
weighting this maximum braking torque with a corrective gain (Fps_i, Fmcp_i) that depends on the gear ratio engaged (i), this corrective gain (Fps_i, Fmcp_i) being dependent as well on the vehicle speed for a given gear ratio (i) and at least one parameter from among braking pressure and brake pedal stroke, and
controlling the electric machine so that the electric braking torque (Bt_regen) applied to the wheels as a complement to dissipative braking is substantially equal to the weighted maximum braking torque.

3. Method according to claim 1, wherein:
pressure on the brake pedal is detected by a BLS-type inductive sensor and/or by a pedal stroke sensor and/or by a hydraulic brake pressure sensor.

4. Method according to claim 1, wherein:
the brake pedal stroke (“pedal_stroke”) is measured by means of a pedal stroke sensor.

5. Method according to claim 1, wherein:
the hydraulic braking pressure (“mc_pressure”) is measured by means of a brake pressure sensor positioned
either at the site of a hydraulic unit that controls the hydraulic pressure applied to the brakes,
or at the site of a master cylinder that transforms pressure on the pedal into hydraulic pressure.

6. Method according to claim 1, wherein, in order to modulate the braking torque of the electric machine (Bt_regen), the method comprises the following steps:
measuring the maximum braking torque (Bt_regen_max) of the electric machine (3),
calculating a first corrective gain (Fps_i) that depends on the vehicle speed and the brake pedal stroke, and/or
calculating a second corrective gain (Fmcp_i) that depends on the vehicle speed and the braking pressure,
multiplying the maximum braking torque by the first (Fps_i) and/or the second (Fmcp_i) calculated corrective gain, and
controlling the electric machine so that the value of the electric braking torque (Bt_regen) applied to the wheels as a complement to dissipative braking is substantially equal to the resultant product.

7. Method according to claim 6, wherein:
the corrective gains (Fps_i, Fmcp_i) depend on the gear ratio (i) engaged.

8. Method according to claim 6, wherein:
the maximum braking torque (Bt_regen_max) of the electric machine is obtained by means of a calculator that controls the torque applied by the power train.

9. Method for improving a hybrid vehicle comprising a heat engine and an electric machine forming a power train, this power train being connected to wheels of the vehicle, wherein:
a pedal stroke sensor and/or a pressure sensor is added so that
the supplemental braking torque (Bt_regen) applied to the wheels by the electric machine when the brake pedal is depressed is modulated as a function of the brake pedal stroke (“pedal_stroke”) and/or the hydraulic braking pressure (“mc_pressure”).
